(19) United States
(12) Patent Application Publication
(10) Pub. No.: US 2002/0103755 A1
(43) Pub. Date: Aug. 1, 2002

(54) Pass-through billing system

(76) Inventor: Chris Jorgensen, Seymour, CT (US)

Correspondence Address: Philmore H. Colburn II, Cantor Colburn LLP, 55 Griffin Road South, Bloomfield, CT, 06002, US

(21) Appl. No.: 09/773,142

(22) Filed: Jan. 31, 2001

(51) Int. Cl. G06F 17/60

(52) U.S. Cl. 705/40

(57) ABSTRACT

A method for passing and delivering a bill generated by a billing party, through an intermediary-billed party, to an end-billed party is disclosed. The method includes sending an initial bill from the billing party to the intermediary-billed party, with the initial bill containing a number of charges included therein. A selection of one or more of the charges appearing on the initial bill is then received from the intermediary-billed party. A final bill for payment by the end-billed party is generated, with the final bill including the intermediary-billed party's selection of one or more of the charges appearing on the initial bill.

### BACKGROUND OF THE INVENTION

This invention relates generally to bill presentment and payment systems and, more particularly, to a method for presenting and processing bills and invoices through an intermediary-billed party to an end-billed party.

Certain business entities may conduct business by purchasing goods from another business entity (such as a supplier or wholesaler) and in turn provide the same goods, along with other goods and professional services, to an individual customer or end user. For example, a building contractor might be hired by an individual homeowner to undertake a kitchen-remodeling project. The project may entail the purchase and installation of new kitchen equipment such as sinks, cabinets, flooring, countertops and appliances. Typically, the homeowner does not pre-purchase such materials and then hire a contractor to come in and simply install the items. Rather, the contractor first purchases from a supplier or retailer the items selected by the homeowner and then installs the purchased items in the home.

Naturally, the cost of the materials purchased by the contractor is passed along to the homeowner, along with the cost of the labor provided and any other associated expenses. However, in first purchasing materials to be installed in a customer's home, the contractor is typically sent an invoice by the supplier, the invoice to be paid directly by the contractor. The contractor may even have an existing business revolving charge or commercial charge account with the particular supplier. Nonetheless, the contractor will typically end up paying the supplier directly for the materials in one form or another. In turn, the contractor will then include those same materials purchased from the supplier in a separate invoice or bill to the homeowner. It can be seen from the foregoing example that although the homeowner is the “real” customer in terms of the purchase of kitchen remodeling materials, both the contractor and the homeowner are ultimately billed for the same materials.

The presentment and payment of bills and invoices can be a costly and time-consuming proposition. The billing parties incur the costs of printing and sending out numerous bills, as well as receiving and processing numerous checks. Accordingly, any improvements in efficiency of billing generation and processing would be desirable.

### BRIEF SUMMARY OF THE INVENTION

The above discussed and other drawbacks and deficiencies of the prior art are overcome or alleviated by a method for passing and delivering a bill generated by a billing party, through an intermediary-billed party, to an end-billed party. The method includes sending an initial bill from the billing party to the intermediary-billed party, with the initial bill containing a number of charges included therein. A selection of one or more of the charges appearing on the initial bill is then received from the intermediary-billed party. A final bill for payment by the end-billed party is generated, with the final bill including the intermediary-billed party's selection of one or more of the charges appearing on the initial bill.

In a preferred embodiment, the intermediary-billed party may include, in addition to the selection of one or more of said charges appearing on the initial bill, additional charges to be included on the final bill. The additional charges represent goods or services provided by the intermediary-billed party to the end-billed party.

### BRIEF DESCRIPTION OF THE DRAWINGS

Referring to the exemplary drawings wherein like elements are numbered alike in the several Figures:

FIGS. 1 and 2 are flow diagrams illustrating a method for passing and delivering a bill generated by a billing party, through an intermediary-billed party, to an end-billed party in accordance with an embodiment of the invention;

FIG. 3 illustrates a computer-generated internet web page, embodying a sample billing statement (including a list of invoices therein) sent to an intermediary-billed party in accordance with an embodiment of the invention;

FIG. 4 illustrates another web page showing a detailed list of items included in a selected invoice in FIG. 3;

FIG. 5 illustrates another web page having a billing form to be filled by the intermediary-billed party;

FIG. 6 illustrates another web page of the billing form shown in FIG. 5;

FIG. 7 illustrates another web page showing an example of a completed bill to be passed from the intermediary-billed party to the end-billed party;

FIG. 8 illustrates another web page showing the example of the completed bill of FIG. 7 received by the end-billed party; and

FIG. 9 illustrates another web page having a computer-generated form in which the end-billed party may pay the completed bill shown in FIG. 8.

### DETAILED DESCRIPTION OF THE INVENTION

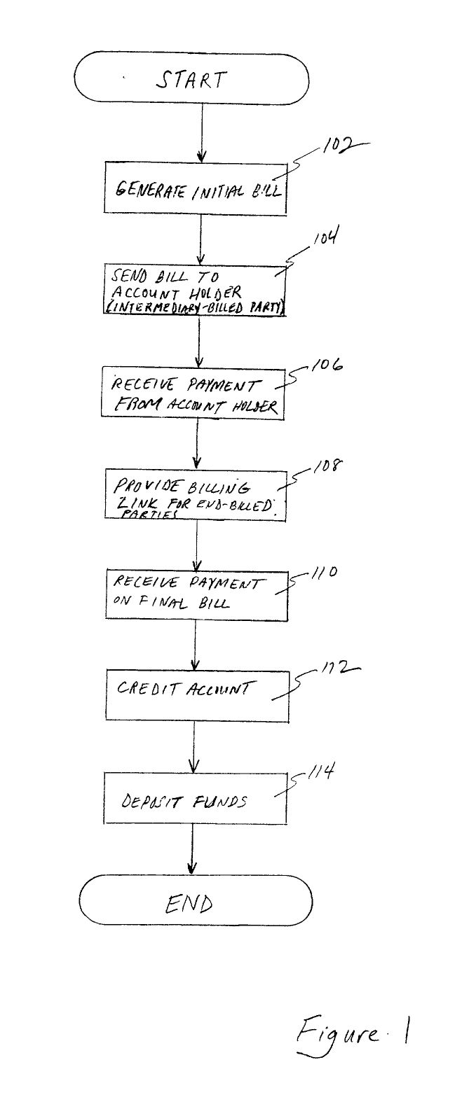

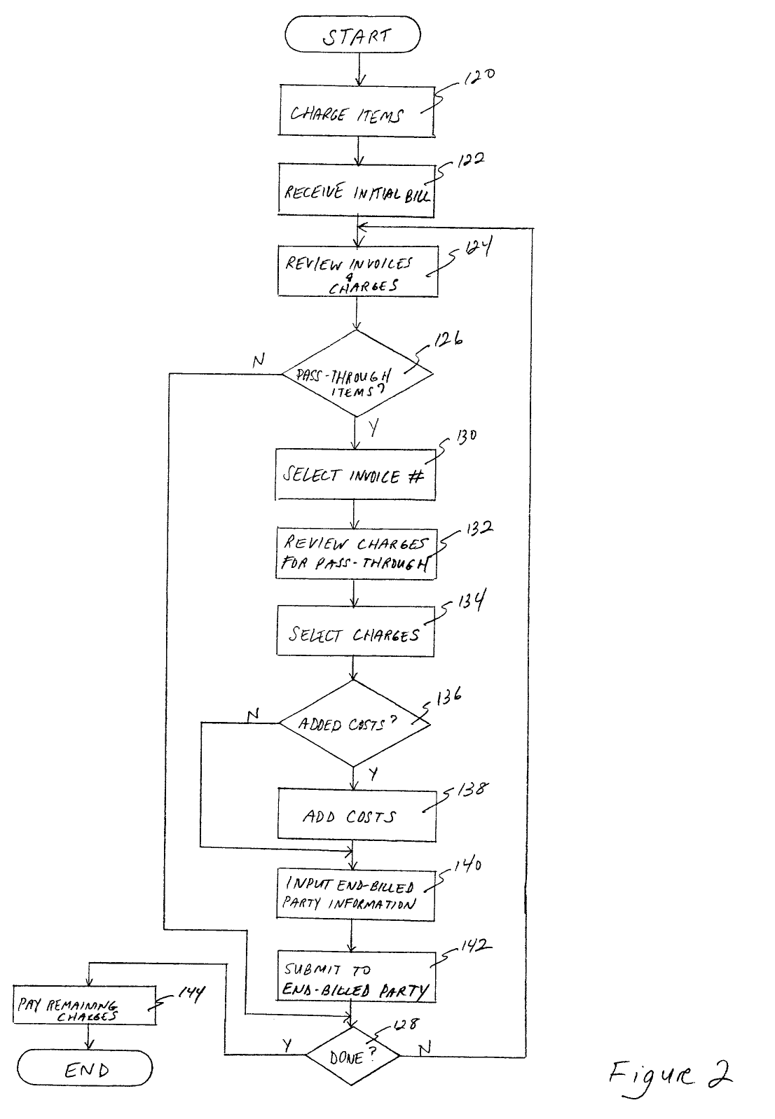

Referring initially to FIGS. 1 and 2, a method 100 for passing and delivering a bill generated by a billing party, through an intermediary-billed party, to an end-billed party in accordance with an embodiment of the invention is shown. For purposes of illustration only, the billing party shall also be referred to hereinafter as “supplier”, the intermediary-billed party shall also be referred to as “contractor” and the end-billed party shall also be referred to as “customer”. However, it will easily be appreciated that the disclosed method may be applicable to other types of business transactions involving multiple parties. Further, the actual billing party in certain instances may be a separate entity from the supplier. For example, the supplier may be a hardware store while the actual billing party may be a credit card provider.

In particular, FIG. 1 illustrates method 100 from the perspective of the billing party. Again, by way of example only, a supplier of goods (billing party) may typically provide a business account for parties, such as contractors, that purchase goods therefrom by using a charge account. Any such purchase of goods will trigger the generation of an initial bill, as indicated at block 102. The initial bill, as is illustrated in greater detail hereinafter, may contain a number of invoices therein charged to the contractor. Eventually, a billing statement is sent at block 104 to the contractor/intermediary-billing party. As was described earlier, a contractor often purchases supply items for use and/or installation on behalf of a customer that has hired the contractor to perform services and supply goods. Thus, it may be fairly stated that the customer is actually the end-user, or purchaser, of the goods. Accordingly, any such purchases made by a contractor on behalf of a customer would otherwise be subsequent billed to the customer by the contractor.

However, in accordance with method 100, the contractor also receives from the supplier (included with the billing statement) the option of passing on selected charges from selected invoices in the billing statement to a particular customer. After reviewing the billing statement and invoices listed thereon, as will be explained in greater detail later, the contractor may select charges from invoices on the billing statement for pass-through, along with inputting additional charges to be billed to the customer. The supplier may then receive, at block 106, any direct payment due from the contractor for items not passed through to other customers.

In the event that the contractor passes through any charges to a customer, the supplier provides a link at block 108 for the customer to remit payment of the contractor's charges to the supplier (or to an account service provider or behalf of the supplier). Again, these charges may include, in addition to purchases made by the contractor, services provided to the consumer by the contractor. Once payment is received at block 110, the supplier will then credit the payment to the outstanding balance on the contractor's account at block 112. Finally, any additional sums charged on behalf of the contractor will then be reimbursed to the contractor by deposit into an account designated by the contractor, at block 114.

Method 100 is further illustrated from the perspective of the contractor in FIG. 2. The contractor purchases a number of items from a supplier at block 120. The items may or may not be directly used for a job done by the contractor for a certain customer. In any event, the contractor will eventually receive an initial bill (block 122) from the supplier, including invoices for purchased items as well as any outstanding invoices. Then, the contractor will review the bill at block 124, including charges listed in specific invoices. Typically, an invoice is generated for a group of items purchased at a given time. After reviewing the bill, the contractor will determine (at decision block 126) whether any of the invoices on the bill contain individual charges to be passed through to a customer. If not, method 100 skips down to decision block 128. If the review process is not completed, method returns to block 124 to continue the process.

Assuming that the billing statement contains at least one invoice containing “pass-through” charges, method 100 then proceeds to block 130, where a specific invoice is selected. Individual charges on the selected invoice are then reviewed at block 132, and the applicable charges are then selected for pass-through at block 134. As stated earlier, method 100 also provides for a feature in which the contractor may also include added costs to be included on the passed-through bill. Thus, a determination is made at decision block 136 if any costs will be added along with a charge or charges. If so, the costs are then added at block 138. If not, no costs are added. In either case, method 100 then proceeds to block 140 where the contractor inputs the information regarding the end-billed party (customer) to receive the final, pass-through bill. When the information is inputted, a final bill is sent to the customer at block 142.

The above process is repeated until completed (as determined at block 128). Afterward, the contractor must pay (block 144) any charges from invoices on the billing statement that are not passed through to other customers.

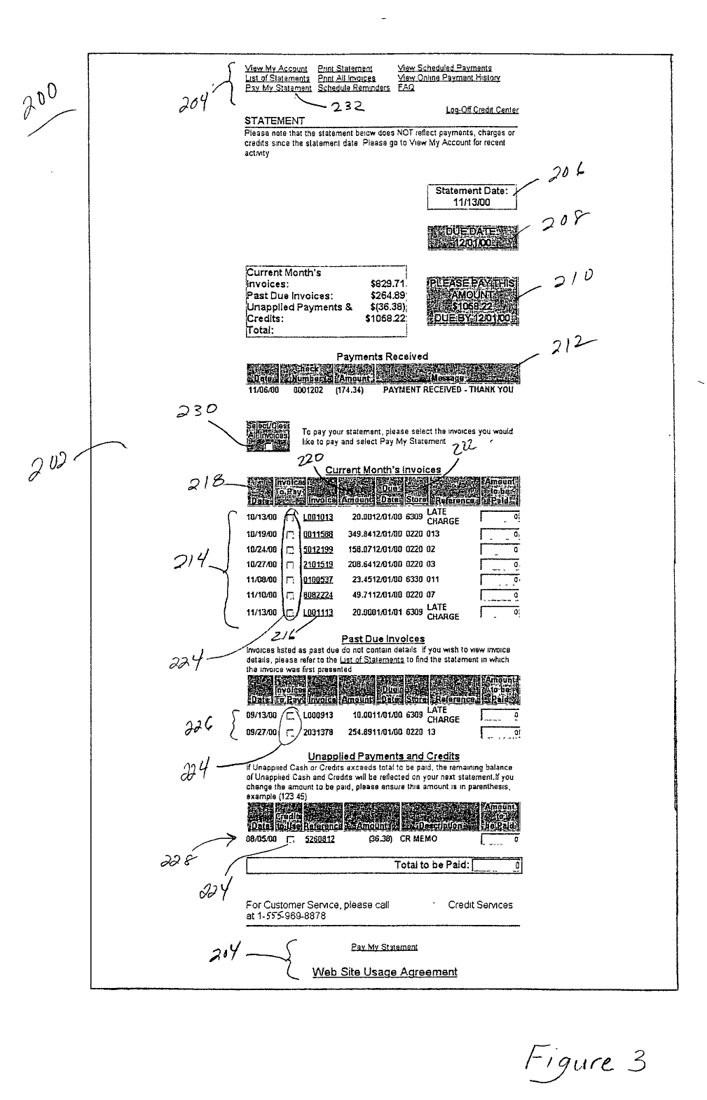

Referring generally now to FIGS. 3 through 9, an exemplary embodiment of method 100 is shown. In a preferred embodiment, method 100 is a computer-implemented process from the point in time at which a billing party (supplier) sends an initial bill to an intermediary-billed party (contractor), to the time that the end-billed party (consumer) remits payment of a passed-through bill and the contractor is reimbursed by the supplier, if applicable. Each step of the process is preferably executed through e-mail and/or an internet web site associated with the supplier.

FIG. 3 shows a computer-generated billing statement 200 sent electronically to a contractor via e-mail or by reference link to an internet web site. In the latter situation, the contractor may access the billing statement 200 by logging on to a supplier's web site and entering an appropriate password. The information contained in billing statement 200 may be transmitted from a web server (not shown) to a web browser (not shown), through a formatted, specialized language called Hypertext Markup Language (HTML), which is typically organized into pages known as web pages. Many web pages include one or more special reference locations or “links” that invoke other web pages. Links allow a web user to easily navigate to other web pages of interest by clicking on the appropriate link with a mouse or other pointing device.

Billing statement 200 is presented on a web page 202 and comprises part of an initial bill generated by a billing party (supplier) and sent to an intermediary-billed party (contractor). A number of links 204 are also provided on both the top and bottom of web page 202. The links 204 provide access to other web pages in order to execute such functions as viewing other statements, printing statements, paying statements and the like. In addition, web page 202 of billing statement 200 contains billing information such as statement date 206, due date 208, amount due 210 and payments received 212. More detailed information is also included on web page 202. In particular, billing statement 200 includes a breakdown of the current invoices 214 charged during the applicable billing period. Each invoice is assigned an invoice number 216 and represents an individual transaction (purchase) made by a representative of the contractor. It will be noted that the invoice breakdown 214 also includes information on the transaction date 218, the transaction amount 220 and the store code 222 of the supplier. In the event that the supplier is a large-volume chain having a number of stores, the store code 222 is used to identify at which store the transaction took place.

A series of input boxes 224 is also included adjacent each invoice number 216. The input boxes 224 allow the contractor to select certain invoices 214 having charges to be paid directly or passed through to a customer (in accordance with block 130 in FIG. 2). In addition to current invoices, web page 202 of billing statement 200 also displays a breakdown on past due invoices 226. The past due invoices 226 may represent charges payable from the contractor which have not yet been paid, or they may represent charges previously passed through to a customer but which have not yet been paid by the customer. Any past due invoice may also be selected for payment or pass-through by selecting an appropriate input box 224 adjacent thereto. If any unapplied payments and credits 228 exist in favor of the contractor, these are also displayed on web page 202. As with the current invoices 214 and the past due invoices, any unapplied payments/credits 228 may also be selected through a corresponding input box 224. A universal input box 230 allows the contractor to either select all invoices appearing in web page 202 or clear all invoices selected. Once the contractor has selected an invoice or invoices 214 to be paid or passed through, the “Pay My Statement” link 232 is clicked.

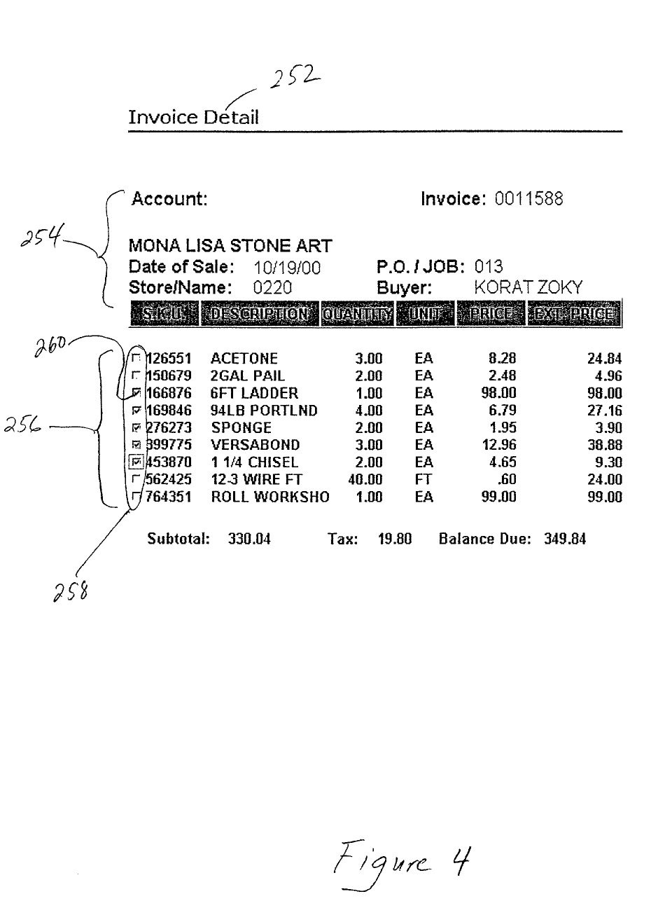

FIG. 4 illustrates an example of another web page 250 accessed after an invoice is selected on web page 202 and link 232 is clicked. In the example illustrated, web page 202 provides an invoice detail 252 on invoice number 0011588, included in the breakdown of current invoices 214 (FIG. 3). Again, invoice 0011588 represents an individual transaction between the contractor and the supplier where the contractor has purchased one or more items from the supplier. The invoice detail 252 lists account information 254 including the date of sale, the store name (or code number), the purchase number and the individual buyer. Following the account information 254, the invoice is broken down into the individual items 256 purchased during the transaction. The items 256 each have an input box 258 associated therewith so that the contractor may select individual items to be passed through and billed to a customer. Those items that are selected will be designated with check marks 260 appearing in the corresponding input box 258. Another link (not shown) is then clicked to continue the process.

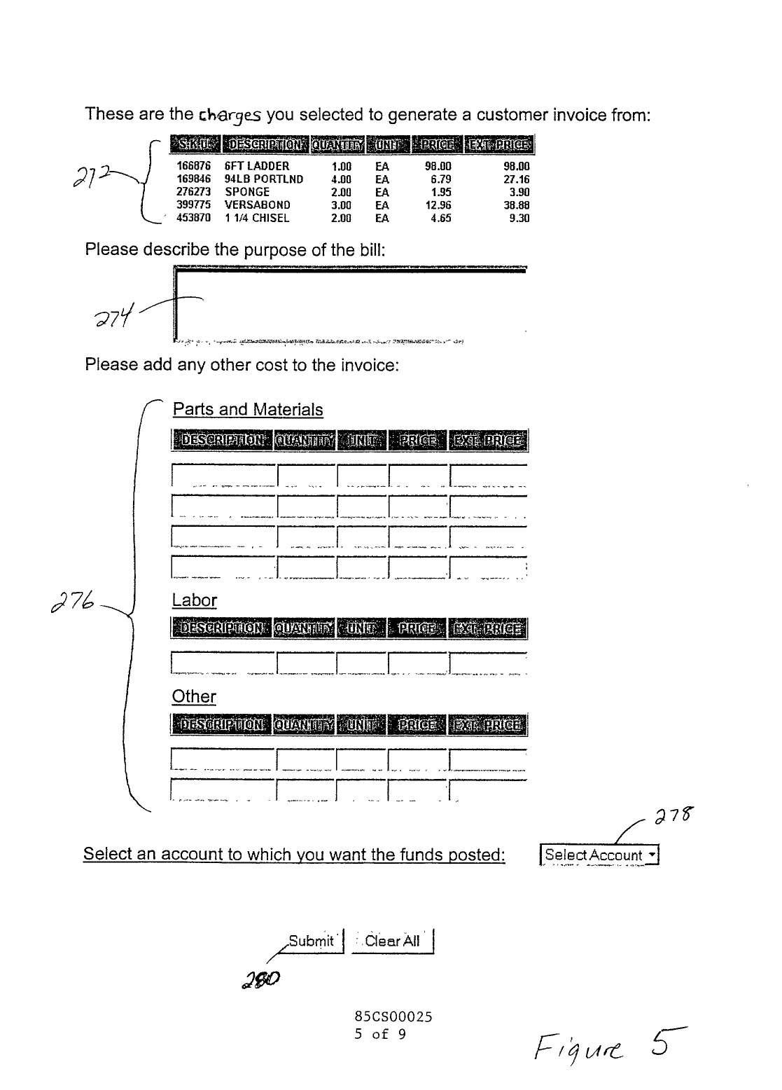

Referring now to FIG. 5, another web page 270 is referenced. At the top of web page 270 is a list 272 of the charges (selected by the contractor from items 256 in FIG. 4) to be passed through to a customer. A text box 274 is provided under the list 272 so that the contractor may enter a verbal description of the goods and services being charged to the customer. As was explained earlier, method 100 also provides a feature whereby the contractor may also input information for other goods not directly purchased from the supplier, as well as services and other charges, to be included in the final bill to a customer. Accordingly, web page 270 also includes an input area 276 for the contractor to add in any additional costs. Assuming the supplier eventually receives a payment on the invoices and other costs, the contractor may select an account from box 278, which includes a drop-down menu (not shown) listing one or more accounts maintained by the contractor. After the information on web page 270 is inputted, clicking the “Submit” link 280 continues the process.

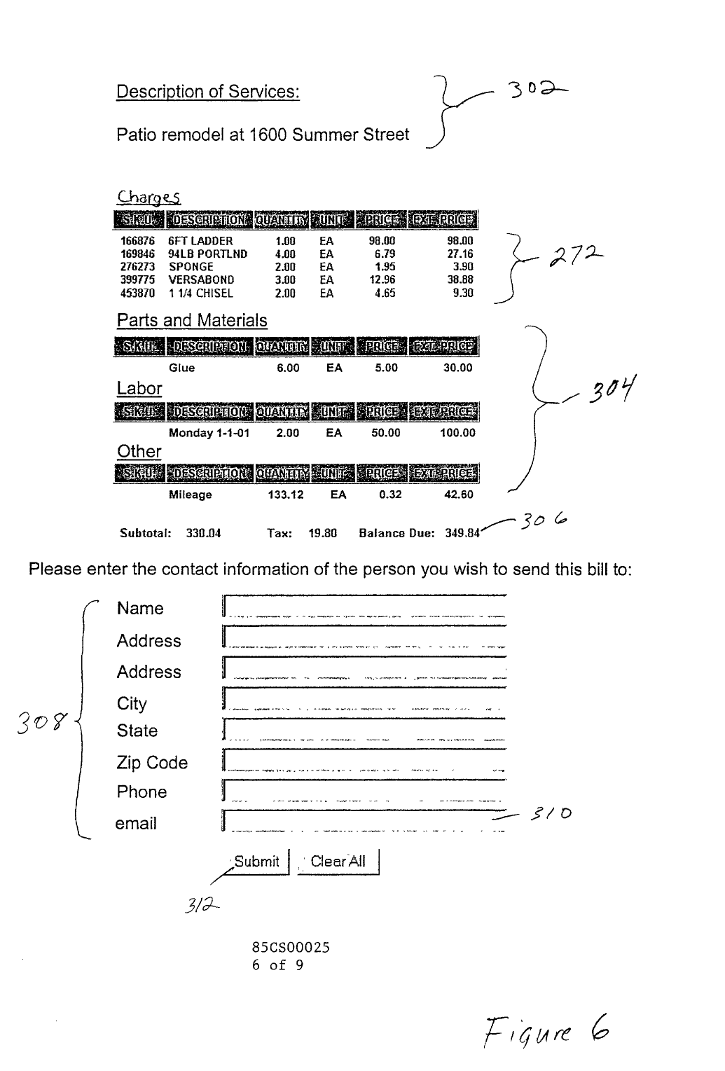

FIG. 6 depicts the next web page 300 appearing after the “Submit” link 280 is clicked. Web page 300 begins with a description of services 302 performed by the contractor on behalf of the customer. This is the information that was inputted in text box 274 of web page 270. Underneath the description of services 302 are the passed through charges 272 and additional costs 304 that were inputted in input area 276 of web page 270. A balance due 306 is then displayed, representing the total of the passed through charges 272, additional costs 304 and tax. The final information to be inputted by the contractor is the customer information, which is entered in input area 308. Input area 308 includes standard information fields such as name, address, and telephone, but also includes an e-mail field 310. In a preferred embodiment of method 100, the consumer will have provided an e-mail address in order to receive a final bill electronically. Once the contractor inputs the customer information, another “Submit” link 312 is clicked.

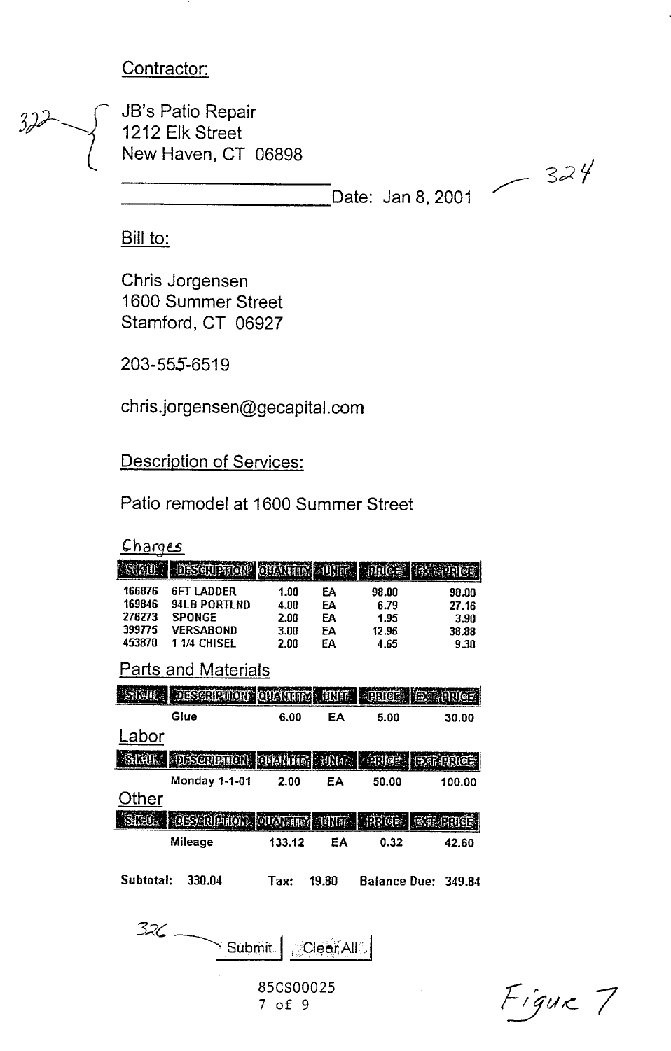

Referring now to FIG. 7, a final web page 320 is presented to the contractor before a final bill is sent to the customer. Final web page 320 summarizes all of the information previously inputted by the contractor, along with the contractor's name and address 322 and the date 324 of the bill. After verifying the information thereon, the contractor submits the final bill by clicking “Submit” link 326.

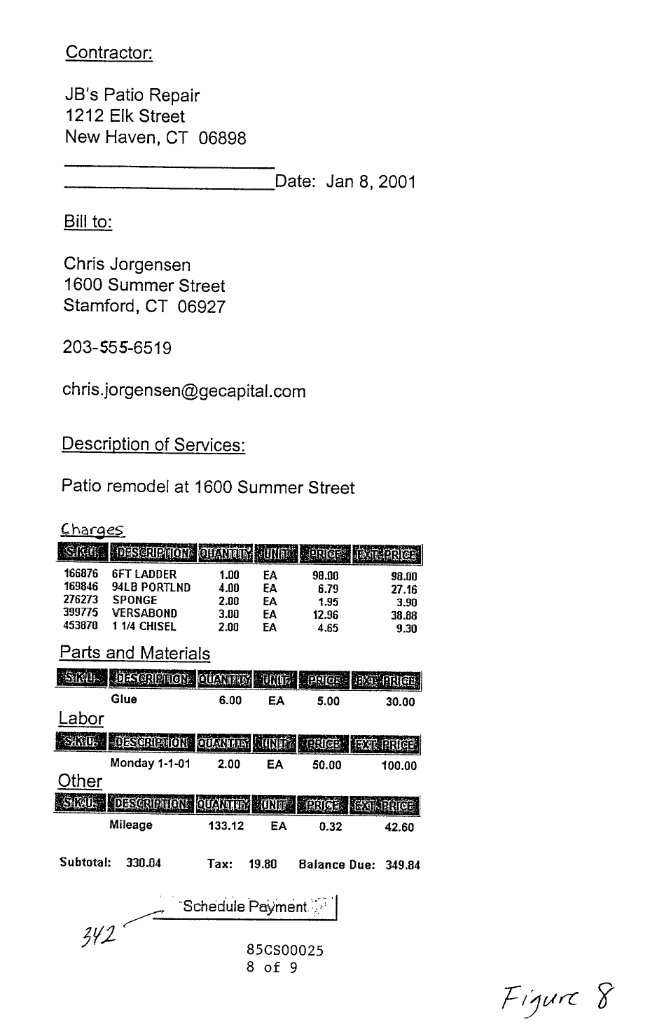

FIG. 8 illustrates an electronic web page 340 accessed by the customer upon receiving notice of a final bill. In a preferred embodiment, the customer receives notification by electronic mail that a bill has been presented. The electronic mail communication (not shown) may provide a link to the supplier's internet web site, as is the case when the contractor receives the initial bill. Upon accessing the supplier web site, the customer may type a temporary password and identification number supplied with the e-mail communication. The password and identification number are used to access web page 340. In an alternative embodiment, the customer may receive a paper bill (not shown), generated by the supplier from the information provided by the contractor. A paper bill would contain the same information included on web page 340, along with a remittance stub and return envelope (not shown).

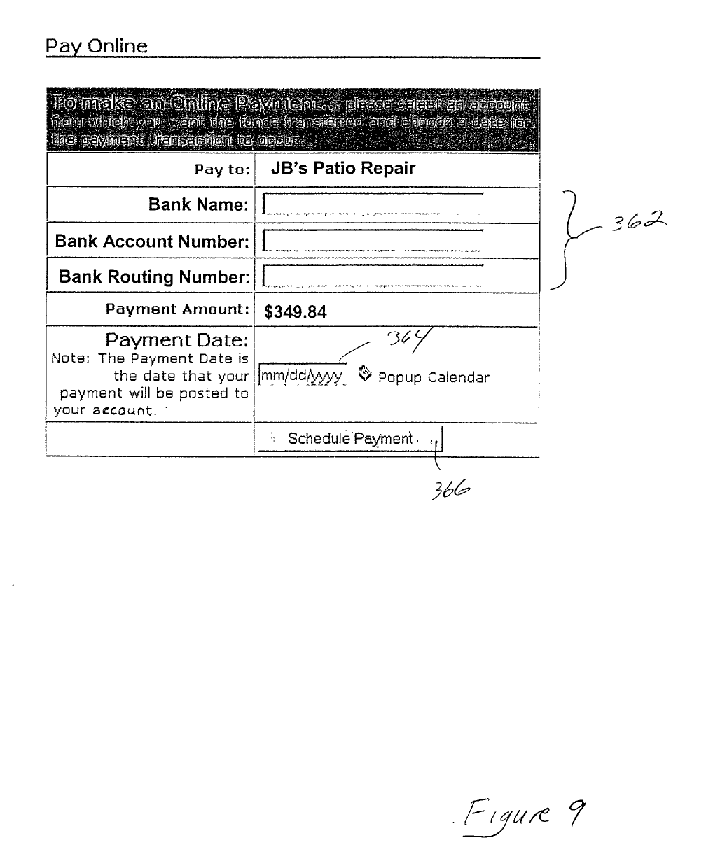

Web page 340 represents a final bill received by the customer and includes the same information contained on web page 320 in FIG. 7. At the bottom of web page 340 is a “Schedule Payment” link 342, which is clicked by the customer in order to facilitate payment of the bill. Finally, FIG. 9 illustrates a web page 360 accessed after the “Schedule Payment” 342 link is clicked. In the embodiment shown, a provision is made for the customer to remit payment electronically by providing a bank account and routing number at input fields 362. The consumer also specifies, in box 364, a date for the transfer of funds to take place. Alternatively, the consumer may also pay the bill with a credit card. After another “Schedule Payment” link 366 is clicked, the information is sent to an accounts receivable system of the supplier where the transaction is posted. Of the $349.84 paid by the customer, an amount representing the cost of the items purchased by the contractor from the supplier will be credited to the contractor's outstanding account. The remaining sum is then reimbursed to the contractor.

Through the implementation of the above described method, the drawbacks and deficiencies of the prior art are overcome. By allowing an intermediary-billed party (who purchases goods from a billing party) to then pass along those charges to an end-billed party, a repetitive generation of invoices is avoided. In the examples illustrated, the contractor avoids the time and expense of separately paying a supplier's invoice and then creating and sending a corresponding invoice to a customer. The supplier may also benefit when the customer is directed to the supplier's web site for payment of the bill, since the customer may be exposed to any advertising the supplier wishes the customer to view.

The disclosed invention may be embodied in the form of computer-implemented processes and apparatuses for practicing those processes. The present invention can also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or as data signal transmitted whether a modulated carrier wave or not, over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for passing and delivering a bill generated by a billing party, through an intermediary-billed party, to an end-billed party, the method comprising:
sending an initial bill from the billing party to the intermediary-billed party, said initial bill containing a number of charges included therein;
receiving, from the intermediary-billed party, a selection of one or more of said charges appearing on said initial bill; and
generating a final bill for payment by the end-billed party, said final bill including said selection of one or more of said charges appearing on said initial bill.

2. The method of claim 1, wherein the intermediary-billed party may include, in addition to said selection of one or more of said charges appearing on said initial bill, additional charges to be included on said final bill, said additional charges representing goods or services provided by the intermediary-billed party to the end-billed party.

3. The method of claim 1, wherein said initial bill and said final bill is generated and sent electronically.

4. The method of claim 3, wherein information contained on said final bill is inputted through an internet web site.

5. The method of claim 3, wherein the end-billed party may access said final bill through an internet web site.

6. The method of claim 3, wherein the end-billed party may electronically pay said final bill to the billing party.

7. The method of claim 6, wherein the intermediary-billed party is reimbursed, from the billing party, an amount equal to said additional charges after the end-billed party has paid said final bill to the billing party.

8. A storage medium encoded with a machine readable computer program code for passing and delivering a bill generated by a billing party, through an intermediary-billed party, to an end-billed party, the storage medium including instructions for causing a computer to implement a method, the method comprising:
sending an initial bill from the billing party to the intermediary-billed party, said initial bill containing a number of charges included therein;
receiving, from the intermediary-billed party, a selection of one or more of said charges appearing on said initial bill; and
generating a final bill for payment by the end-billed party, said final bill including said selection of one or more of said charges appearing on said initial bill.

9. The storage medium of claim 8, wherein the intermediary-billed party may include, in addition to said selection of one or more of said charges appearing on said initial bill, additional charges to be included on said final bill, said additional charges representing goods or services provided by the intermediary-billed party to the end-billed party.

10. The storage medium of claim 8, wherein said initial bill and said final bill is generated and sent electronically.

11. The storage medium of claim 10, wherein information contained on said final bill is inputted through an internet web site.

12. The storage medium of claim 10, wherein the end-billed party may access said final bill through an internet web site.

13. The storage medium of claim 10, wherein the end-billed party may electronically pay said final bill to the billing party.

14. The storage medium of claim 13, wherein the intermediary-billed party is reimbursed, from the billing party, an amount equal to said additional charges after the end-billed party has paid said final bill to the billing party.

15. A computer data signal for passing and delivering a bill generated by a billing party, through an intermediary-billed party, to an end-billed party, the computer data signal comprising code configured to cause a processor to implement a method, the method comprising:
sending an initial bill from the billing party to the intermediary-billed party, said initial bill containing a number of charges included therein;
receiving, from the intermediary-billed party, a selection of one or more of said charges appearing on said initial bill; and
generating a final bill for payment by the end-billed party, said final bill including said selection of one or more of said charges appearing on said initial bill.

16. The computer data signal of claim 15, wherein the intermediary-billed party may include, in addition to said selection of one or more of said charges appearing on said initial bill, additional charges to be included on said final bill, said additional charges representing goods or services provided by the intermediary-billed party to the end-billed party.

17. The computer data signal of claim 15, wherein said initial bill and said final bill is generated and sent electronically.

18. The computer data signal of claim 17, wherein information contained on said final bill is inputted through an internet web site.

19. The computer data signal of claim 17, wherein the end-billed party may access said final bill through an internet web site.

20. The computer data signal of claim 17, wherein the end-billed party may electronically pay said final bill to the billing party.

21. The computer data signal of claim 20, wherein the intermediary-billed party is reimbursed, from the billing party, an amount equal to said additional charges after the end-billed party has paid said final bill to the billing party.
